(19) United States
(12) Patent Application Publication
(10) Pub. No.: US 2025/0003765 A1
(43) Pub. Date: Jan. 2, 2025

(54) SYSTEMS AND METHODS FOR EFFICIENTLY PRODUCING ACCURATE SLAM-BASED MAPS

(71) Applicant: Woven by Toyota, Inc., Tokyo (JP)

(72) Inventor: Yucong Lin, Ann Arbor, MI (US)

(73) Assignee: Woven by Toyota, Inc., Tokyo (JP)

(21) Appl. No.: 18/344,174

(22) Filed: Jun. 29, 2023

(51) Int. Cl. G01C 21/00

(52) U.S. Cl. CPC G01C 21/3815; G01C 21/3848

(57) ABSTRACT

System, methods, and other embodiments described herein relate to implementing a mapping management system. In one embodiment, a method includes receiving trace data; processing the trace data to provide a group of passes within a lane segment; determining error measurements for the group of passes within the lane segment; receiving a criterion; and determining an estimated number of passes to satisfy the criterion based on the error measurements.

### TECHNICAL FIELD

The subject matter described herein relates, in general, to estimating the amount of trace data required to produce a map of an environment, and, more particularly, to efficiently producing such a map with a desired level of accuracy.

### BACKGROUND

Vehicles may be equipped with systems such as Simultaneous Localization and Mapping (SLAM) technology that allows a mobile platform to move through an unknown environment while simultaneously determining the location of the mobile platform and mapping the environment. Typically, SLAM techniques operate over discrete units of time and use odometry information to estimate a location of the vehicle and range sensing data (e.g., from cameras or lidar) to correct the estimate.

Since SLAM techniques are often used to map the environment as the vehicle moves through the environment, SLAM techniques have been used to produce geometric maps of the environment. For example, odometry information and camera images may be obtained via multiple passes of a mobile platform through the environment, with an emphasis on the detection of static objects, then processed to create a geometric map of the environment. Where such processing does not occur in real-time, such SLAM techniques may be referred to as offline SLAM.

### SUMMARY

In one embodiment, example systems and methods relate to a manner of implementing mapping management strategies for connected autonomous vehicles.

In one embodiment, a mapping management system is disclosed. The mapping management system includes one or more processors and a memory communicably coupled to the one or more processors. The memory stores a command module including instructions that when executed by the one or more processors cause the one or more processors to receive trace data; process the trace data to provide a group of passes within a lane segment; determine error measurements for the group of passes within the lane segment; receive a criterion; and determine an estimated number of passes to satisfy the criterion based on the error measurements.

In one embodiment, a non-transitory computer-readable medium including instructions that when executed by one or more processors cause the one or more processors to perform one or more functions is disclosed. The instructions include instructions to receive trace data; process the trace data to provide a group of passes within a lane segment; determine error measurements for the group of passes within the lane segment; receive a criterion; and determine an estimated number of passes to satisfy the criterion based on the error measurements.

In one embodiment, a method for implementing mapping management strategies for connected autonomous vehicles is disclosed. In one embodiment, the method includes receiving trace data; processing the trace data to provide a group of passes within a lane segment; determining error measurements for the group of passes within the lane segment; receiving a criterion; and determining an estimated number of passes to satisfy the criterion based on the error measurements.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a vehicle within which systems and methods disclosed herein may be implemented.

FIG. 2 illustrates one embodiment of a mapping management system that is associated with implementing mapping management strategies.

FIG. 3 illustrates one embodiment of the mapping management system of FIG. 2 in a cloud-computing environment.

FIGS. 4A-B illustrate examples of strategies for correcting an estimated trajectory.

FIGS. 5A-B illustrates examples of processing trace data into lane segments.

FIG. 6 illustrates one example of correcting estimated trajectories within a lane segment based on keypoint association heuristics.

FIG. 7 illustrates one example of trajectories that may be evaluated for pose error.

FIG. 8A illustrates one example of a method for graphing error measurements versus the number of passes within a lane segment.

FIG. 8B illustrates another example of a method for graphing error measurements versus the number of passes within a lane segment.

FIG. 9 illustrates an example flowchart of a method that is associated with implementing a mapping management system.

### DETAILED DESCRIPTION

Systems, methods, and other embodiments associated with implementing a mapping management system. Vehicles with SLAM may be used to create geometric maps by travelling in a loop repeatedly (or making repeated passes for an area of interest). As the number of passes increases, generally a more accurate geometric map can be made. In addition, the estimated trajectory of the vehicle may also be determined more accurately (e.g., because a more accurate geometric map is available).

Current methods of generating accurate geometric maps do not provide means for estimating the resources required for their creation. Accordingly, techniques are described herein for evaluating error estimates of estimated trajectories as compared to a reference trajectory, such as when additional passes are added to a lane segment. In this manner, the improvement in error estimates as additional passes are recorded may be used to determine the number of passes required to obtain a similar level of accuracy with respect to similar unmapped lane segments. For example, if analysis of a one-mile test loop of highway shows that eight passes are sufficient for a desired level of accuracy, then such number of passes may be relied on in planning for additional mapping of the highway (e.g., the next 20 miles of highway).

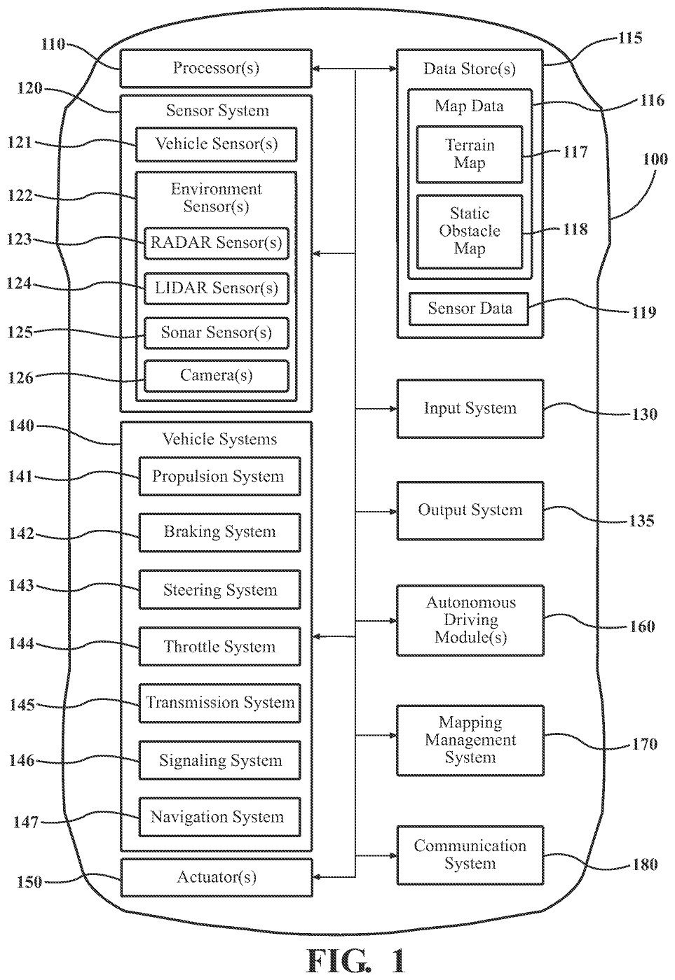

Referring to FIG. 1, an example of a vehicle 100 is illustrated. As used herein, a “vehicle” is any form of motorized transport. In one or more implementations, vehicle 100 is an automobile. While arrangements will be described herein with respect to automobiles, it will be understood that embodiments are not limited to automobiles. In some implementations, vehicle 100 may be any robotic device or form of motorized transport that, for example, includes sensors to perceive aspects of the surrounding environment, and thus benefits from the functionality discussed herein associated with mapping management strategies. As a further note, this disclosure generally discusses vehicle 100 as traveling on a roadway with surrounding vehicles, which are intended to be construed in a similar manner as vehicle 100 itself. That is, the surrounding vehicles may include any vehicle that may be encountered on a roadway by vehicle 100.

Vehicle 100 also includes various elements. It will be understood that in various embodiments it may not be necessary for vehicle 100 to have all of the elements shown in FIG. 1. Vehicle 100 may have any combination of the various elements shown in FIG. 1. Further, vehicle 100 may have additional elements to those shown in FIG. 1. In some arrangements, vehicle 100 may be implemented without one or more of the elements shown in FIG. 1. While the various elements are shown as being located within vehicle 100 in FIG. 1, it will be understood that one or more of these elements may be located external to vehicle 100. Further, the elements shown may be physically separated by large distances. For example, as discussed, one or more components of the disclosed system may be implemented within a vehicle while further components of the system are implemented within a cloud-computing environment or other system that is remote from vehicle 100.

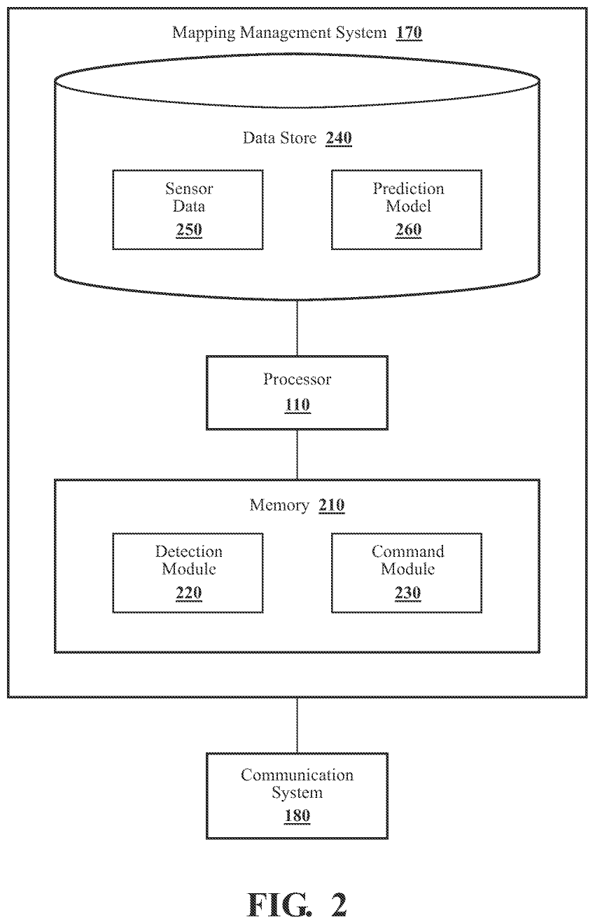

Some of the possible elements of vehicle 100 are shown in FIG. 1 and will be described along with subsequent figures. However, a description of many of the elements in FIG. 1 will be provided after the discussion of FIGS. 2-9 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In either case, vehicle 100 includes a mapping management system 170 that is implemented to perform methods and other functions as disclosed herein relating to implementing mapping management strategies. As will be discussed in greater detail subsequently, mapping management system 170, in various embodiments, is implemented partially within vehicle 100, and as a cloud-based service. For example, in one approach, functionality associated with at least one module of mapping management system 170 is implemented within vehicle 100 while further functionality is implemented within a cloud-based computing system.

With reference to FIG. 2, one embodiment of mapping management system 170 of FIG. 1 is further illustrated. Mapping management system 170 is shown as including processor(s) 110 from vehicle 100 of FIG. 1. Accordingly, processor(s) 110 may be a part of mapping management system 170, mapping management system 170 may include a separate processor from processor 110(s) of vehicle 100, or mapping management system 170 may access processor 110(s) through a data bus or another communication path. In one embodiment, mapping management system 170 includes memory 210, which stores detection module 220 and command module 230. Memory 210 is a random-access memory (RAM), read-only memory (ROM), a hard-disk drive, a flash memory, or other suitable memory for storing detection module 220 and command module 230. Detection module 220 and command module 230 are, for example, computer-readable instructions that when executed by processor(s) 110 cause processor(s) 110 to perform the various functions disclosed herein.

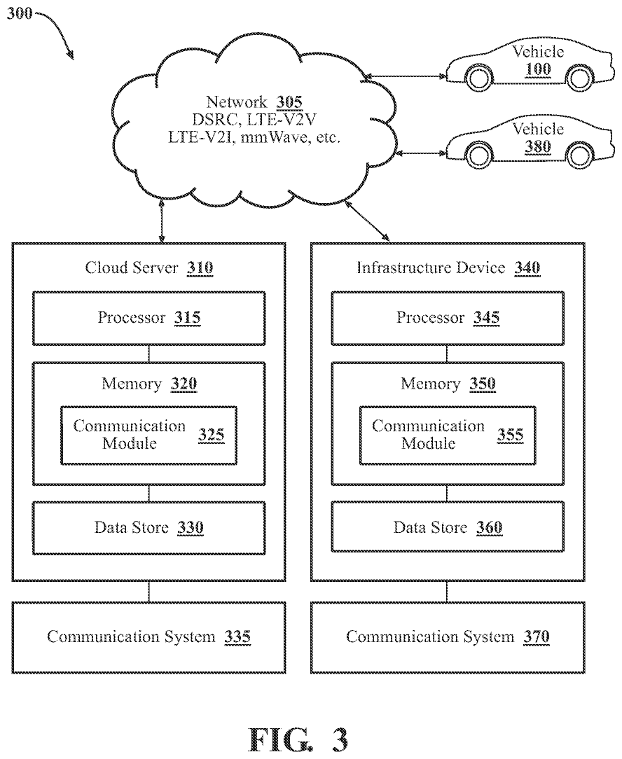

Mapping management system 170 as illustrated in FIG. 2 is generally an abstracted form of mapping management system 170 as may be implemented between vehicle 100 and a cloud-computing environment. FIG. 3, which is further described below, illustrates one example of a cloud-computing environment 300 that may be implemented along with mapping management system 170. As illustrated in FIG. 3, mapping management system 170 may be embodied at least in part within cloud-computing environment 300.

With reference to FIG. 2, detection module 220 generally includes instructions that function to control processor(s) 110 to receive data inputs from one or more sensors of vehicle 100. The inputs are, in one embodiment, observations of one or more objects in an environment proximate to vehicle 100, other aspects about the surroundings, or both. As provided for herein, detection module 220, in one embodiment, acquires sensor data 250 that includes at least camera images and odometry data. In further arrangements, detection module 220 acquires sensor data 250 from further sensors such as radar 123, LiDAR 124, and other sensors as may be suitable for obtaining odometry data, range-sensing data, or data relating to the location of vehicle 100.

Accordingly, detection module 220, in one embodiment, controls the respective sensors to provide sensor data 250. Additionally, while detection module 220 is discussed as controlling the various sensors to provide sensor data 250, in one or more embodiments, detection module 220 may employ other techniques to acquire sensor data 250 that are either active or passive. For example, detection module 220 may passively sniff sensor data 250 from a stream of electronic information provided by the various sensors to further components within vehicle 100. Moreover, detection module 220 may undertake various approaches to fuse data from multiple sensors when providing sensor data 250, from sensor data acquired over a wireless communication link (e.g., v2v) from one or more of the surrounding vehicles, or from a combination thereof. Thus, sensor data 250, in one embodiment, represents a combination of perceptions acquired from multiple sensors.

In addition to locations of surrounding vehicles, sensor data 250 may also include, for example, information about lane markings, and so on. Moreover, detection module 220, in one embodiment, controls the sensors to acquire sensor data about an area that encompasses 360 degrees about vehicle 100, which may then be stored in sensor data 250. In some embodiments, such area sensor data may be used to provide a comprehensive assessment of the surrounding environment around vehicle 100. Of course, in alternative embodiments, detection module 220 may acquire the sensor data about a forward direction alone when, for example, vehicle 100 is not equipped with further sensors to include additional regions about the vehicle or the additional regions are not scanned due to other reasons (e.g., unnecessary due to known current conditions).

Moreover, in one embodiment, mapping management system 170 includes database 240. Database 240 is, in one embodiment, an electronic data structure stored in memory 210 or another data store and that is configured with routines that may be executed by processor(s) 110 for analyzing stored data, providing stored data, organizing stored data, and so on. Thus, in one embodiment, database 240 stores data used by the detection module 220 and command module 230 in executing various functions. In one embodiment, database 240 includes sensor data 250 along with, for example, metadata that characterize various aspects of sensor data 250. For example, the metadata may include location coordinates (e.g., longitude and latitude), relative map coordinates or tile identifiers, time/date stamps from when separate sensor data 250 was generated, and so on.

Detection module 220, in one embodiment, is further configured to perform additional tasks beyond controlling the respective sensors to acquire and provide sensor data 250. For example, detection module 220 may include instructions for packaging information within sensor data 250 into trace data for analysis as described herein

In some embodiments, detection module 220 may record trace data, such as odometry and range sensing data provided by a simultaneous localization and mapping system of vehicle 100. In some embodiments, trace data may also include additional information, such as GPS information corresponding to the odometry and range sensing data. For instance, as a vehicle 100 moves from a first point to a second point, camera images may be recorded and analyzed to identify keypoints associated with an area of interest (e.g., edges, lane markers), which may then be stored in trace data. In association with such camera images, odometry information from the acceleration, braking, or other vehicle movements may also be analyzed by detection module 220 to determine a location of vehicle 100 at the time of such camera images, which may then be stored in trace data. Further, GPS location data at the time of such camera images may be also recorded by detection module 220 in a trace data. In some embodiments, the camera data, odometry data, or GPS data may be recorded at slightly different times, such as where such data is obtained from different vehicle systems. Accordingly, in some embodiments, detection module 220 or command module 230 may perform analysis to align camera, odometry, or GPS data with respect to time, such as by interpolation or other techniques known in the art. In some embodiments, trace data may represent one session of a combination of odometry, range sensing or GPS data, while in other embodiments the trace data may contain multiple sessions of a combination of odometry, range sensing or GPS data.

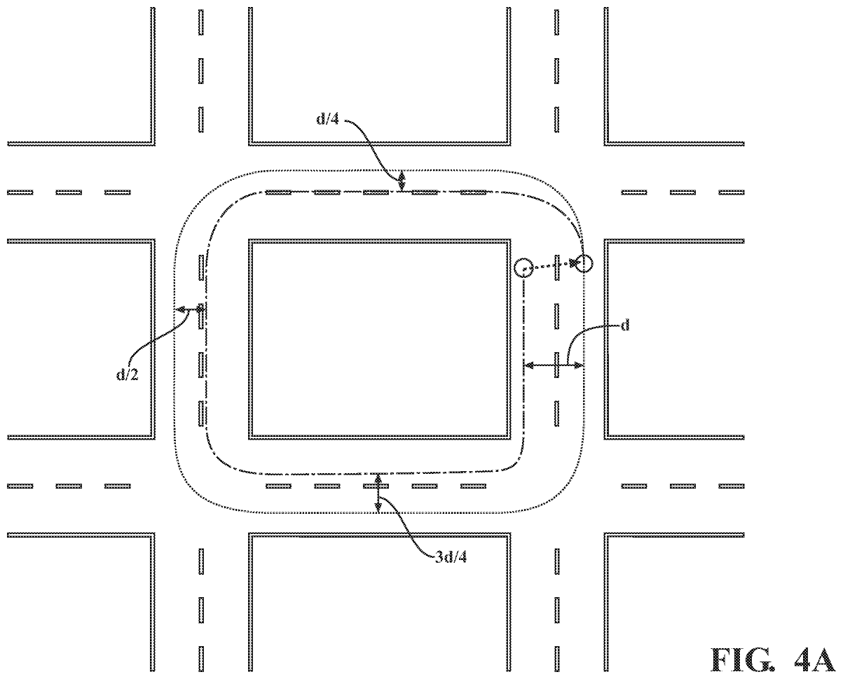

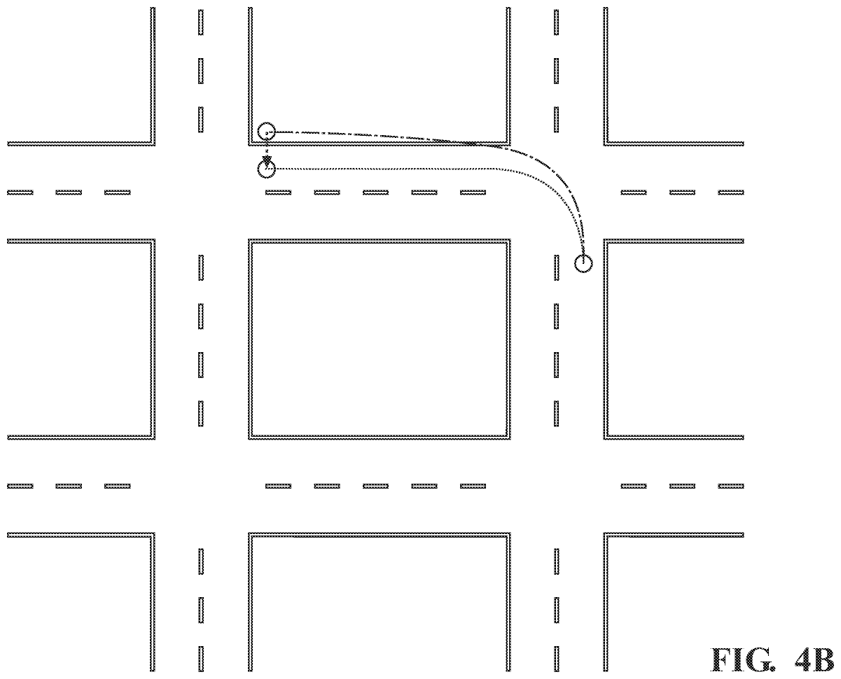

In some embodiments, command module 230 may receive trace data, such as from sensor data 250. Given that odometry data and GPS data may contain errors relative to the true location of when such data was recorded, command module 230 may use methods such as loop closure, constraining traces to defined boundaries (e.g., valid path of travel such as a road), and other approaches known in the art to correct an estimated trajectory recorded in a trace. For example, the keypoints of a common feature (e.g., intersection markings) as shown in FIG. 4A may be used to correct the estimated trajectory such that the loop given by the estimated trajectory returns to a valid location relative to the common feature. As another example, as shown in FIG. 4B an estimated trajectory may be corrected as known in the art where an estimated trajectory would violate a boundary condition, such as where the estimated trajectory shows the vehicle drifting into a vehicle barrier.

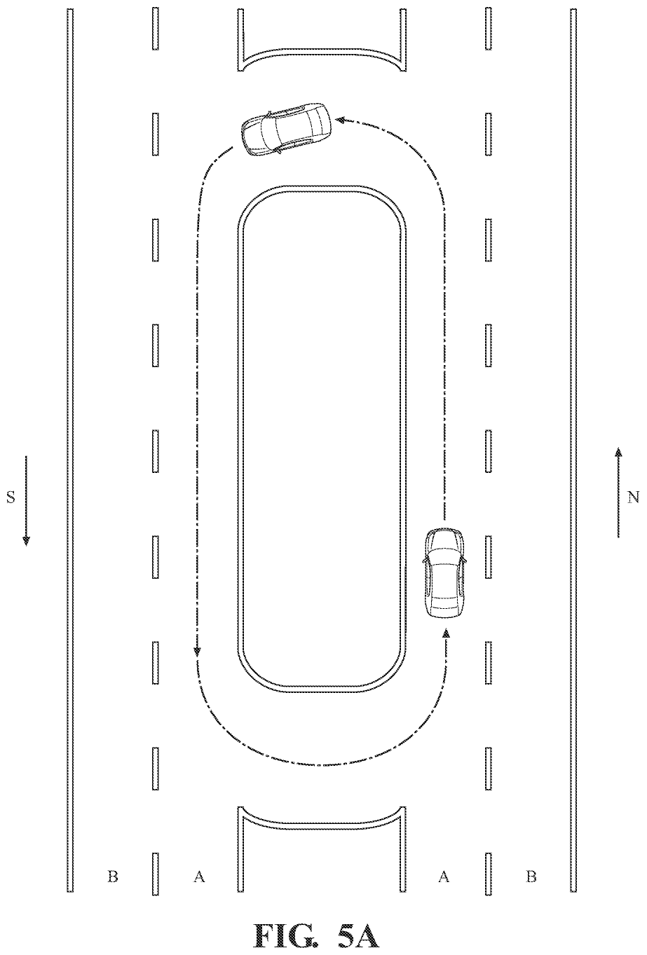

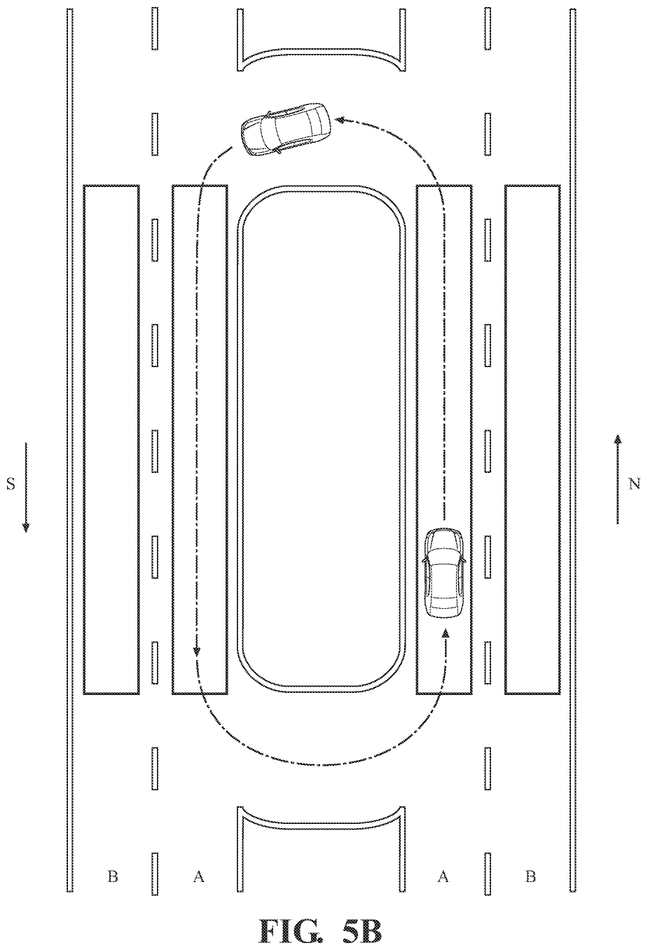

As trace data may provide camera, odometry, and GPS data over a large area, command module 230 may divide trace data into lane segments. For example, a vehicle may have driven in a loop up and down a highway as shown in FIG. 5A. Upon receiving the trace from such a vehicle, as shown in FIG. 5B, command module 230 may divide the trace into two segments (e.g., northbound lanes, southbound lanes). Each segment may then be divided into lane segments (e.g., northbound lane A, northbound lane B, southbound lane A, southbound lane B). Further, each time the trace data passes sequentially through a lane segment, the trace data within the lane segment may be recorded as a lane segment pass (or pass for short). Accordingly, each lane segment pass may be identified based on the segment, lane segment, and lane segment pass number (e.g., a pass with the identifier NA2 may signify it is the second pass recorded through the lane segment for northbound lane A, similarly NA5 may signify that the data is the fifth pass through the same lane segment). In some embodiments, a lane segment may be defined with respect to geographic areas other than road lanes in which vehicles may travel, such as a parking structure.

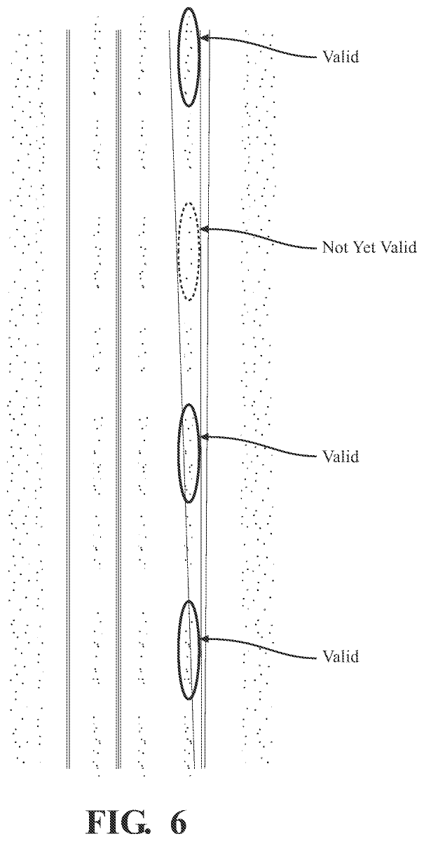

In some embodiments, command module 230 may determine valid associations of keypoints within lane segments. As shown in FIG. 6, each lane segment pass may contain information regarding the location of keypoints along a path of travel by a vehicle. Such keypoints may correspond, for example, to lane markers on the sides of lane in which the vehicle was driven. Association heuristics may be used to determine if there is a sufficient number of keypoints in proximity to each other to be marked as valid. For instance, a dashed road line may be composed of lane marker dashes of a certain length and width, such that keypoints too far apart relative to the dimensions of an individual lane marker dash cannot be associated with each other.

Initially, a first pass through an environment may only produce a few keypoints sufficient to satisfy the association heuristics. However, when additional passes are made through the same lane segment, keypoints from such additional passes may be aggregated so as to allow more groups of keypoints to satisfy the association heuristics. In addition, as more keypoints are validated, such valid keypoints may be used to improve the estimated trajectory of the vehicle as known in the art. For example, if data from a first and third pass are sufficient to establish one or more groups of valid keypoints (e.g., lane markers), command module 230 may determine whether an adjustment to the second lane segment pass may cause its data to better align with the groups of valid keypoints. Further, any such corrections to an estimated trajectory within a lane segment pass may also provide for correction of the estimated trajectory beyond the lane segment (e.g., to the trace as a whole, to a subsequent lane segment pass).

Accordingly, as the number of passes within a lane segment increases, the estimated trajectory based on SLAM techniques is likely to closer approximate a groundtruth trajectory of the vehicle. However, such improvements typically diminish as the number as the number of passes increases (e.g., because fewer possible lane markers are left to validate with every pass added to the lane segment data). As such, in some embodiments, command module 230 may analyze the results of adding each additional pass to lane segment data to determine a number of passes required to achieve a level of desired accuracy.

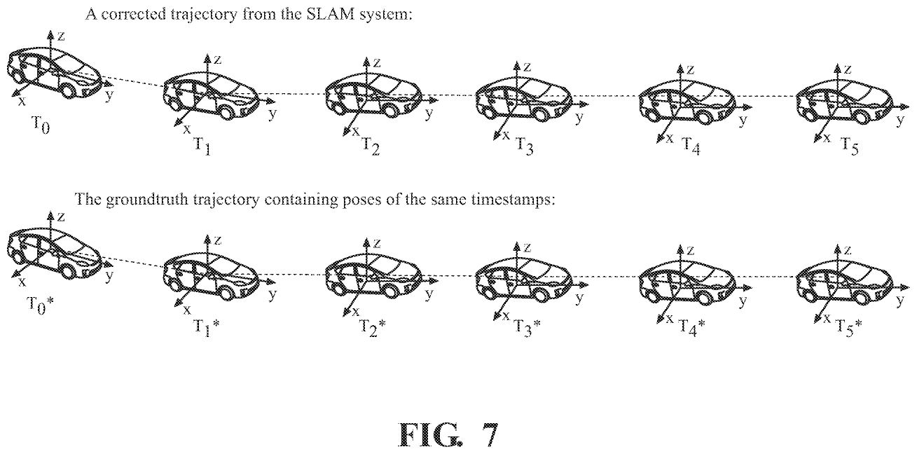

As shown in FIG. 7, an estimated trajectory from trace data may contain pose data (e.g., x, y, z, pitch, yaw, roll) relative to a series of timestamps (e.g., pose Tᵢ at time i). In addition, a groundtruth trajectory may also be supplied with the trace data, which contains highly accurate pose data of the vehicle when it was recording the trace (e.g., pose Tᵢ* at time i). For example, such groundtruth trajectory may be supplied by highly accurate positioning systems known in the art (e.g., DGPS, RTK GPS).

Based on the estimated trajectory and the groundtruth trajectory, Absolute Pose Error (APE) translation and rotation may be determined by command module 230 as follows:

$${APE}_{trans} = \frac{1}{N} {\sum }_{i = 0}^{N} {‖ {T}_{i} ⊖ {T}_{i}^{*} ‖}_{trans} \qquad ( 1 )$$

$${APE}_{rot} = \frac{1}{N} {\sum }_{i = 0}^{N} {‖ {T}_{i} ⊖ {T}_{i}^{*} ‖}_{rot} \qquad ( 2 )$$

where N is the number of poses of Tᵢ being evaluated, Tᵢ is the pose of the vehicle according to the estimated trajectory at time i, and Tᵢ* is the pose of the vehicle according to the groundtruth trajectory.

In addition, Relative Pose Error (RPE) translation and rotation may be determined by command module 230 as follows:

$${RPE}_{trans} = \frac{1}{N} \frac{1}{{N}_{j}} {\sum }_{i = 0}^{N} {\sum }_{j ∈ {Ω}_{i}} {‖ ( {T}_{i} ⊖ {T}_{j} ) ⊖ ( {T}_{i}^{*} ⊖ {T}_{j}^{*} ) ‖}_{trans} \qquad ( 3 )$$

$${RPE}_{trans} = \frac{1}{N} \frac{1}{{N}_{j}} {\sum }_{i = 0}^{N} {\sum }_{j ∈ {Ω}_{i}} {‖ ( {T}_{i} ⊖ {T}_{j} ) ⊖ ( {T}_{i}^{*} ⊖ {T}_{j}^{*} ) ‖}_{rot} \qquad ( 4 )$$

where N is the number of poses of Tᵢ being evaluated, Nⱼ is the total number of neighboring poses of Tⱼ to be evaluated around pose Tᵢ, Tᵢ is the pose of the vehicle according to the estimated trajectory at time i, Tⱼ is the pose of the vehicle according to the estimated trajectory at time j, Tᵢ*is the pose of the vehicle according to the groundtruth trajectory at time i, and Tⱼ* is the pose of the vehicle according to the groundtruth trajectory at time j.

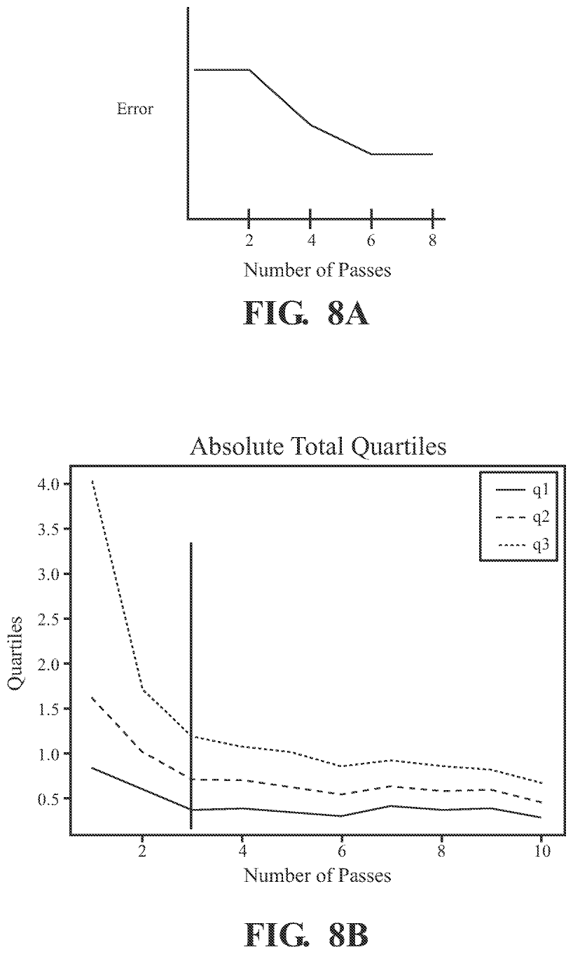

An example of an error calculation for a lane segment versus the number of passes added to a lane segment is shown in FIG. 8A, which demonstrates that the average error calculated tends to decrease as the number of passes added increases. Accordingly, command module 230 given a trace may calculate error measurements for a lane segment based on the number of passes provided within. In some embodiments, command module 230 may further use the error measurements obtained to estimate how additional error measurements may decrease if a further number of passes were to be recorded. For example, command module 230 may use curve-fitting techniques as known in the art or other predictive methods (e.g., modeling, machine learning) to predict likely values for error measurements if additional passes are provided. As such, if a desired error measurement is below that of what is provided by the number of passes recorded, command module 230 may nonetheless be able to estimate a number of passes to achieve the desired error measurement.

Another example of an error calculation for a lane segment versus the number of passes added to a lane segment is shown in FIG. 8B, which shows an example of how first, second, and third quartiles tend to decrease as the number of passes added increases. Such an embodiment may be realized for example by not performing the averaging function as shown in Equation (1), Equation (2), Equation (3), or Equation (4). By not performing averaging, such equations would instead return N measures of absolute or relative pose error, which may then be processed into first, second, and third quartiles. In such an embodiment, multiple thresholds may be used as criteria to evaluate the quartiles.

In some embodiments, command module 230 may display a graph of error measurements for one or more lane segments. In some embodiments, the display of the graph may further include trendlines, which may also show estimates of additional error measurements that may be obtained if additional passes are obtained. In some embodiments, command module 230 may be configured to receive instructions as to the type of error measurements to be used in determining a sufficient number of passes. For example, a user may select APE, RPE, or other measurements known in the art. In addition, command module 230 may be configured to receive instructions as to the specific criterion to be used in determining a sufficient number of passes relative to a selected error measurement. For example, achieving a value above or below a threshold in relation to the specified error measurement may be used to estimate the sufficient number of passes. As another example, the relative change in value of one or more error measurements as passes are added may be evaluated against one or more thresholds (e.g., estimate the number of passes based on when APEₜᵣₐₙₛ does not improve by at least 5% as passes are added).

In some embodiments, an estimated trajectory after a number of passes has been added may be used as a groundtruth trajectory in calculating error measurements. For example, a vehicle may need to operate in an area where highly accurate positioning may not be available (e.g., a tunnel). Accordingly, in such an environment or for other purposes, the estimated trajectory based on number of passes recorded within a lane segment (e.g., after all available passes have been added to the lane segment) may be used as a substitute groundtruth trajectory for a lesser number of passes (e.g., as a best available trajectory).

In some embodiments, command module 230 may determine whether a lane segment, which has been analyzed to determine the error measurements relative to the number of passes, is similar to another lane segment. For example, command module 230 may decide whether two such lane segments are more or less similar based on geography, road curvature, lane configuration, road surface condition, etc. If command module 230 determines an unmapped lane segment is similar to a mapped lane segment (e.g., by a desired measure of similarly exceeding a threshold), command module 230 may provide an estimate of the number of passes for the unmapped lane segment based on the mapped lane segment.

In some embodiments, command module 230 may track the extent to which the number of passes for a desired error measurement deviates from its predictions. For example, command module 230 may record where the number of passes turned out to be lower than required, where the number of passes turned out to be higher that required, where the estimated number of passes increased as the number of passes originally predicted was performed, and so on. In view of such information, command module 230 may determine a statistical measure (e.g., standard deviation) of the extent of such deviations. For example, among similar lane segments, command module 230 may determine that the average predicted number of passes is 8.3 with a standard deviation of 1.2. In some embodiments, command module 230 may select the number of passes to be performed based on such aggregate statistical analysis (e.g., given a mean of 8.3, a value of 9 passes may be selected; if a standard deviation of 1.2 is also given, a value of 10 may be selected to ensure less possibility that an insufficient number of passes will be performed to achieve a desired accuracy).

In some embodiments, command module 230 may provide a user interface for displaying information relating to the estimation of the number of passes, which may also include providing for receiving selections or inputs by a user (e.g., via a touchscreen, keyboard, remote interface). For example, a user may be given a graph of error measurements vs. number of passes based on a lane segment that has been analyzed, which may provide a mechanism for adjusting the type of error measurements to be used. As another example, command module 230 may receive a selection of a criterion for estimating a sufficient number of passes and display a representation of such criterion on the graph of error measurements vs. number of passes (e.g., as a horizontal line showing where the threshold is; as a region showing the allowed amount of change in the error measurements for satisfying a selected criterion if another pass is added). In some embodiments, command module 230 may display information describing criterion for determining if lane segments are similar, which may also include providing for receiving changes to such information. In some embodiments, command module 230 in displaying the graph of error measurements vs. number of passes may show a trendline; the estimated number of passes required to achieve a desired accuracy, a prior history of results based on data from prior traces or similar lane segments; and so on.

It should be appreciated that the command module 230 in combination with a prediction model 260 can form a computational model such as a machine learning logic, deep learning logic, a neural network model, or another similar approach. In one embodiment, the prediction model 260 is a statistical model such as a regression model that estimates the number of passes required for a desired accuracy based on sensor data 250 or other sources of information as described herein. Accordingly, the model 260 can be a polynomial regression (e.g., least weighted polynomial regression), least squares or another suitable approach.

Moreover, in alternative arrangements, the prediction model 260 is a probabilistic approach such as a hidden Markov model. In either case, the command module 230, when implemented as a neural network model or another model, in one embodiment, electronically accepts the sensor data 250 as an input. Accordingly, the command module 230 in concert with the prediction model 260 produce various determinations/assessments as an electronic output that characterizes the noted aspect as, for example, a single electronic value. Moreover, in further aspects, the mapping management system 170 can collect the noted data, log responses, and use the data and responses to subsequently further train the model 260.

In one embodiment, command module 230 generally includes instructions that function to control processor(s) 110 or collection of processors in the cloud-computing environment 300 as shown in FIG. 3 for implementing a mapping management system.

With reference to FIG. 3, vehicle 100 may be connected to a network 305, which allows for communication between vehicle 100 and cloud servers (e.g., cloud server 310), infrastructure devices (e.g., infrastructure device 340), other vehicles (e.g., vehicle 380), and any other systems connected to network 305. With respect to network 305, such a network may use any form of communication or networking to exchange data, including but not limited to the Internet, Directed Short Range Communication (DSRC) service, LTE, 5G, millimeter wave (mmWave) communications, and so on.

Cloud server 310 is shown as including a processor 315 that may be a part of mapping management system 170 through network 305 via communication unit 335. In one embodiment, cloud server 310 includes a memory 320 that stores a communication module 325. Memory 320 is a random-access memory (RAM), read-only memory (ROM), a hard-disk drive, a flash memory, or other suitable memory for storing communication module 325. Communication module 325 is, for example, computer-readable instructions that when executed by processor 315 causes processor 315 to perform the various functions disclosed herein. Moreover, in one embodiment, cloud server 310 includes database 330. Database 330 is, in one embodiment, an electronic data structure stored in a memory 320 or another data store and that is configured with routines that may be executed by processor 315 for analyzing stored data, providing stored data, organizing stored data, and so on.

Infrastructure device 340 is shown as including a processor 345 that may be a part of mapping management system 170 through network 305 via communication unit 370. In one embodiment, infrastructure device 340 includes a memory 350 that stores a communication module 355. Memory 350 is a random-access memory (RAM), read-only memory (ROM), a hard-disk drive, a flash memory, or other suitable memory for storing communication module 355. Communication module 355 is, for example, computer-readable instructions that when executed by processor 345 causes processor 345 to perform the various functions disclosed herein. Moreover, in one embodiment, infrastructure device 340 includes a database 360. Database 360 is, in one embodiment, an electronic data structure stored in memory 350 or another data store and that is configured with routines that may be executed by processor 345 for analyzing stored data, providing stored data, organizing stored data, and so on.

Accordingly, in addition to information obtained from sensor data 250, mapping management system 170 may obtain information from cloud servers (e.g., cloud server 310), infrastructure devices (e.g., infrastructure device 340), other vehicles (e.g., vehicle 380), and any other systems connected to network 305. In some embodiments, any or all functionality of the command module 230 discussed with respect to mapping management system 170 may be implemented in cloud server 310. In addition, information relating to a groundtruth trajectory for a vehicle may be provided to command module 230 or cloud server 310 by infrastructure device 340 (e.g., a temporary or permanent installation providing highly accurate vehicle location measurements).

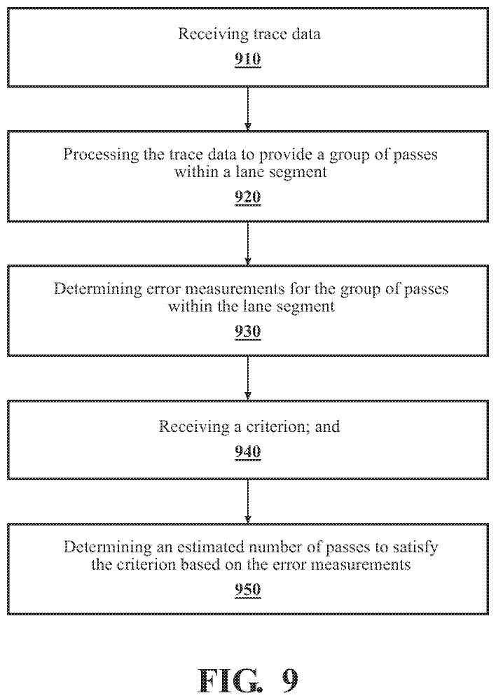

FIG. 9 illustrates a flowchart of a method 900 that is associated with implementing a mapping management system. Method 900 will be discussed from the perspective of the mapping management system 170 of FIGS. 1 and 2. While method 900 is discussed in combination with the mapping management system 170, it should be appreciated that the method 900 is not limited to being implemented within the mapping management system 170 but is instead one example of a system that may implement the method 900.

At 910, command module 230 may receive trace data. For example, command module 230 may receive trace data from sensor data 250 or via cloud-computing environment 300. In some embodiments, command module 230 may receive trace data containing odometry and range sensing data provided by a simultaneous localization and mapping system of vehicle 100. In some embodiments, trace data may also include additional information, such as GPS information corresponding to the odometry and range sensing data. In some embodiments, the camera data, odometry data, or GPS data may be recorded at slightly different times, such as where such data is obtained from different vehicle systems. Accordingly, in some embodiments, command module 230 may also perform analysis to align camera, odometry, or GPS data with respect to time, such as by interpolation or other techniques known in the art. In some embodiments, trace data may represent one session of a combination of odometry, range sensing, or GPS data, while in other embodiments the trace data may contain multiple sessions of a combination of odometry, range sensing or GPS data.

At 920, command module 230 may process the trace data to provide a group of passes within a lane segment. For example, upon receiving the trace data, command module 230 may divide the trace into two segments (e.g., northbound lanes, southbound lanes) and each segment may then be divided into lane segments (e.g., northbound lane A, northbound lane B, southbound lane A, southbound lane B). Further, each time the trace data passes sequentially through a lane segment, the trace data within the lane segment may be recorded as a lane segment pass (or pass). In addition, each lane segment pass may be identified based on the segment, lane segment, and lane segment pass number (e.g., a pass with the identifier NA2).

At 930, command module 230 may determine error measurements for the group of passes within the lane segment. In some embodiments, as part of the determination of error measurements by command module 230, error correction to one or more estimated trajectories may occur with each pass added to a lane segment pass. For example, a first estimated trajectory may be corrected based on the first pass, a second estimated trajectory may be corrected based on the first pass and second pass, a third estimated trajectory may be corrected based on the first, second, and third passes). In some embodiments, when one trajectory is corrected, it may also lead to other trajectories being corrected. Such correction may occur with the addition of each pass to a lane segment by various techniques known in the art, such as methods involving loop closure, enforcing boundary constraints, the use of association heuristics to define valid keypoints, and so on. Accordingly, with each pass added, error measurements may be calculated based on position or pose. For example, absolute pose error or relative pose error may be calculated with the addition of each pass to a lane segment once correction to any estimated trajectories has been implemented, such that one or error measurements may be associated with the addition of each pass to a lane segment. In regard to the types of error measurement that may be used, command module 230 may perform any error measurements with respect to pose or position as known in the art, such as those known for comparing estimated trajectories with a groundtruth trajectory, a best available estimated trajectory, etc.

At 940, command module 230 may receive a criterion, which may include any criterion known in the art for evaluating the error measurements as described above. For example, command module 230 may receive one or more thresholds or range of values by which to evaluate the error measurements across a number of passes within a lane segment.

At 950, command module 230 may determine an estimated number of passes required to satisfy the criterion based on the error measurements. For example, achieving a value above or below a threshold criterion in relation to the specified error measurement may be used to estimate the sufficient number of passes. As another example, the relative change in value of one or more error measurements as passes are added may be evaluated against one or more thresholds.

FIG. 1 will now be discussed in full detail as an example environment within which the system and methods disclosed herein may operate. In some instances, vehicle 100 is configured to switch selectively between various modes, such as an autonomous mode, one or more semi-autonomous operational modes, a manual mode, etc. Such switching may be implemented in a suitable manner, now known, or later developed. “Manual mode” means that all of or a majority of the navigation/maneuvering of the vehicle is performed according to inputs received from a user (e.g., human driver). In one or more arrangements, vehicle 100 may be a conventional vehicle that is configured to operate in only a manual mode.

In one or more embodiments, vehicle 100 is an autonomous vehicle. As used herein, “autonomous vehicle” refers to a vehicle that operates in an autonomous mode. “Autonomous mode” refers to using one or more computing systems to control vehicle 100, such as providing navigation/maneuvering of vehicle 100 along a travel route, with minimal or no input from a human driver. In one or more embodiments, vehicle 100 is either highly automated or completely automated. In one embodiment, vehicle 100 is configured with one or more semi-autonomous operational modes in which one or more computing systems perform a portion of the navigation/maneuvering of the vehicle along a travel route, and a vehicle operator (i.e., driver) provides inputs to the vehicle to perform a portion of the navigation/maneuvering of vehicle 100 along a travel route.

Vehicle 100 may include one or more processors 110. In one or more arrangements, processor(s) 110 may be a main processor of vehicle 100. For instance, processor(s) 110 may be an electronic control unit (ECU). Vehicle 100 may include one or more data stores 115 for storing one or more types of data. Data store(s) 115 may include volatile memory, non-volatile memory, or both. Examples of suitable data store(s) 115 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. Data store(s) 115 may be a component of processor(s) 110, or data store 115 may be operatively connected to processor(s) 110 for use thereby. The term “operatively connected,” as used throughout this description, may include direct or indirect connections, including connections without direct physical contact.

In one or more arrangements, data store(s) 115 may include map data 116. Map data 116 may include maps of one or more geographic areas. In some instances, map data 116 may include information or data on roads, traffic control devices, road markings, structures, features, landmarks, or any combination thereof in the one or more geographic areas. Map data 116 may be in any suitable form. In some instances, map data 116 may include aerial views of an area. In some instances, map data 116 may include ground views of an area, including 360-degree ground views. Map data 116 may include measurements, dimensions, distances, information, or any combination thereof for one or more items included in map data 116. Map data 116 may also include measurements, dimensions, distances, information, or any combination thereof relative to other items included in map data 116. Map data 116 may include a digital map with information about road geometry. Map data 116 may be high quality, highly detailed, or both.

In one or more arrangements, map data 116 may include one or more terrain maps 117. Terrain map(s) 117 may include information about the ground, terrain, roads, surfaces, other features, or any combination thereof of one or more geographic areas. Terrain map(s) 117 may include elevation data in the one or more geographic areas. Terrain map(s) 117 may be high quality, highly detailed, or both. Terrain map(s) 117 may define one or more ground surfaces, which may include paved roads, unpaved roads, land, and other things that define a ground surface.

In one or more arrangements, map data 116 may include one or more static obstacle maps 118. Static obstacle map(s) 118 may include information about one or more static obstacles located within one or more geographic areas. A “static obstacle” is a physical object whose position does not change or substantially change over a period of time and whose size does not change or substantially change over a period of time. Examples of static obstacles include trees, buildings, curbs, fences, railings, medians, utility poles, statues, monuments, signs, benches, furniture, mailboxes, large rocks, hills. The static obstacles may be objects that extend above ground level. The one or more static obstacles included in static obstacle map(s) 118 may have location data, size data, dimension data, material data, other data, or any combination thereof, associated with it. Static obstacle map(s) 118 may include measurements, dimensions, distances, information, or any combination thereof for one or more static obstacles. Static obstacle map(s) 118 may be high quality, highly detailed, or both. Static obstacle map(s) 118 may be updated to reflect changes within a mapped area.

Data store(s) 115 may include sensor data 119. In this context, “sensor data” means any information about the sensors that vehicle 100 is equipped with, including the capabilities and other information about such sensors. As will be explained below, vehicle 100 may include sensor system 120. Sensor data 119 may relate to one or more sensors of sensor system 120. As an example, in one or more arrangements, sensor data 119 may include information on one or more LIDAR sensors 124 of sensor system 120.

In some instances, at least a portion of map data 116 or sensor data 119 may be located in data stores(s) 115 located onboard vehicle 100. Alternatively, or in addition, at least a portion of map data 116 or sensor data 119 may be located in data stores(s) 115 that are located remotely from vehicle 100.

As noted above, vehicle 100 may include sensor system 120. Sensor system 120 may include one or more sensors. “Sensor” means any device, component, or system that may detect or sense something. The one or more sensors may be configured to sense, detect, or perform both in real-time. As used herein, the term “real-time” means a level of processing responsiveness that a user or system senses as sufficiently immediate for a particular process or determination to be made, or that enables the processor to keep up with some external process.

In arrangements in which sensor system 120 includes a plurality of sensors, the sensors may work independently from each other. Alternatively, two or more of the sensors may work in combination with each other. In such an embodiment, the two or more sensors may form a sensor network. Sensor system 120, the one or more sensors, or both may be operatively connected to processor(s) 110, data store(s) 115, another element of vehicle 100 (including any of the elements shown in FIG. 1), or any combination thereof. Sensor system 120 may acquire data of at least a portion of the external environment of vehicle 100 (e.g., nearby vehicles).

Sensor system 120 may include any suitable type of sensor. Various examples of different types of sensors will be described herein. However, it will be understood that the embodiments are not limited to the particular sensors described. Sensor system 120 may include one or more vehicle sensors 121. Vehicle sensor(s) 121 may detect, determine, sense, or acquire in a combination thereof information about vehicle 100 itself. In one or more arrangements, vehicle sensor(s) 121 may be configured to detect, sense, or acquire in a combination thereof position and orientation changes of vehicle 100, such as, for example, based on inertial acceleration. In one or more arrangements, vehicle sensor(s) 121 may include one or more accelerometers, one or more gyroscopes, an inertial measurement unit (IMU), a dead-reckoning system, a global navigation satellite system (GNSS), a global positioning system (GPS), a navigation system 147, other suitable sensors, or any combination thereof. Vehicle sensor(s) 121 may be configured to detect, sense, or acquire in a combination thereof one or more characteristics of vehicle 100. In one or more arrangements, vehicle sensor(s) 121 may include a speedometer to determine a current speed of vehicle 100.

Alternatively, or in addition, sensor system 120 may include one or more environment sensors 122 configured to acquire, sense, or acquire in a combination thereof driving environment data. “Driving environment data” includes data or information about the external environment in which an autonomous vehicle is located or one or more portions thereof. For example, environment sensor(s) 122 may be configured to detect, quantify, sense, or acquire in any combination thereof obstacles in at least a portion of the external environment of vehicle 100, information/data about such obstacles, or a combination thereof. Such obstacles may be comprised of stationary objects, dynamic objects, or a combination thereof. Environment sensor(s) 122 may be configured to detect, measure, quantify, sense, or acquire in any combination thereof other things in the external environment of vehicle 100, such as, for example, lane markers, signs, traffic lights, traffic signs, lane lines, crosswalks, curbs proximate to vehicle 100, off-road objects, etc.

Various examples of sensors of sensor system 120 will be described herein. The example sensors may be part of the one or more environment sensor(s) 122, the one or more vehicle sensors 121, or both. However, it will be understood that the embodiments are not limited to the particular sensors described.

As an example, in one or more arrangements, sensor system 120 may include one or more radar sensors 123, one or more LIDAR sensors 124, one or more sonar sensors 125, one or more cameras 126, or any combination thereof. In one or more arrangements, camera(s) 126 may be high dynamic range (HDR) cameras or infrared (IR) cameras.

Vehicle 100 may include an input system 130. An “input system” includes any device, component, system, element or arrangement or groups thereof that enable information/data to be entered into a machine. Input system 130 may receive an input from a vehicle passenger (e.g., a driver or a passenger). Vehicle 100 may include an output system 135. An “output system” includes any device, component, or arrangement or groups thereof that enable information/data to be presented to a vehicle passenger (e.g., a person, a vehicle passenger, etc.).

Vehicle 100 may include one or more vehicle systems 140. Various examples of vehicle system(s) 140 are shown in FIG. 1. However, vehicle 100 may include more, fewer, or different vehicle systems. It should be appreciated that although particular vehicle systems are separately defined, each or any of the systems or portions thereof may be otherwise combined or segregated via hardware, software, or a combination thereof within vehicle 100. Vehicle 100 may include a propulsion system 141, a braking system 142, a steering system 143, throttle system 144, a transmission system 145, a signaling system 146, a navigation system 147, other systems, or any combination thereof. Each of these systems may include one or more devices, components, or combinations thereof, now known or later developed.

Navigation system 147 may include one or more devices, applications, or combinations thereof, now known or later developed, configured to determine the geographic location of the vehicle 100, to determine a travel route for vehicle 100, or to determine both. Navigation system 147 may include one or more mapping applications to determine a travel route for vehicle 100. Navigation system 147 may include a global positioning system, a local positioning system, a geolocation system, or any combination thereof.

Processor(s) 110, mapping management system 170, automated driving module(s) 160, or any combination thereof may be operatively connected to communicate with various aspects of vehicle system(s) 140 or individual components thereof. For example, returning to FIG. 1, processor(s) 110, automated driving module(s) 160, or a combination thereof may be in communication to send or receive information from various aspects of vehicle system(s) 140 to control the movement, speed, maneuvering, heading, direction, etc. of vehicle 100. Processor(s) 110, mapping management system 170, automated driving module(s) 160, or any combination thereof may control some or all of these vehicle system(s) 140 and, thus, may be partially or fully autonomous.

Processor(s) 110, mapping management system 170, automated driving module(s) 160, or any combination thereof may be operable to control at least one of the navigation or maneuvering of vehicle 100 by controlling one or more of vehicle systems 140 or components thereof. For instance, when operating in an autonomous mode, processor(s) 110, mapping management system 170, automated driving module(s) 160, or any combination thereof may control the direction, speed, or both of vehicle 100. Processor(s) 110, mapping management system 170, automated driving module(s) 160, or any combination thereof may cause vehicle 100 to accelerate (e.g., by increasing the supply of fuel provided to the engine), decelerate (e.g., by decreasing the supply of fuel to the engine, by applying brakes), change direction (e.g., by turning the front two wheels), or perform any combination thereof. As used herein, “cause” or “causing” means to make, force, compel, direct, command, instruct, enable, or in any combination thereof an event or action to occur or at least be in a state where such event or action may occur, either in a direct or indirect manner.

Vehicle 100 may include one or more actuators 150. Actuator(s) 150 may be any element or combination of elements operable to modify, adjust, alter, or in any combination thereof one or more of vehicle systems 140 or components thereof to responsive to receiving signals or other inputs from processor(s) 110, automated driving module(s) 160, or a combination thereof. Any suitable actuator may be used. For instance, actuator(s) 150 may include motors, pneumatic actuators, hydraulic pistons, relays, solenoids, and piezoelectric actuators, just to name a few possibilities.

Vehicle 100 may include one or more modules, at least some of which are described herein. The modules may be implemented as computer-readable program code that, when executed by processor(s) 110, implement one or more of the various processes described herein. One or more of the modules may be a component of processor(s) 110, or one or more of the modules may be executed on or distributed among other processing systems to which processor(s) 110 is operatively connected. The modules may include instructions (e.g., program logic) executable by processor(s) 110. Alternatively, or in addition, data store(s) 115 may contain such instructions.

In one or more arrangements, one or more of the modules described herein may include artificial or computational intelligence elements, e.g., neural network, fuzzy logic, or other machine learning algorithms. Further, in one or more arrangements, one or more of the modules may be distributed among a plurality of the modules described herein. In one or more arrangements, two or more of the modules described herein may be combined into a single module.

Vehicle 100 may include one or more autonomous driving modules 160. Automated driving module(s) 160 may be configured to receive data from sensor system 120 or any other type of system capable of capturing information relating to vehicle 100, the external environment of the vehicle 100, or a combination thereof. In one or more arrangements, automated driving module(s) 160 may use such data to generate one or more driving scene models. Automated driving module(s) 160 may determine position and velocity of vehicle 100. Automated driving module(s) 160 may determine the location of obstacles, obstacles, or other environmental features including traffic signs, trees, shrubs, neighboring vehicles, pedestrians, etc.

Automated driving module(s) 160 may be configured to receive, determine, or in a combination thereof location information for obstacles within the external environment of vehicle 100, which may be used by processor(s) 110, one or more of the modules described herein, or any combination thereof to estimate: a position or orientation of vehicle 100; a vehicle position or orientation in global coordinates based on signals from a plurality of satellites or other geolocation systems; or any other data/signals that could be used to determine a position or orientation of vehicle 100 with respect to its environment for use in either creating a map or determining the position of vehicle 100 in respect to map data.

Automated driving module(s) 160 either independently or in combination with mapping management system 170 may be configured to determine travel path(s), current autonomous driving maneuvers for vehicle 100, future autonomous driving maneuvers, modifications to current autonomous driving maneuvers, etc. Such determinations by automated driving module(s) 160 may be based on data acquired by sensor system 120, driving scene models, data from any other suitable source such as determinations from sensor data 250, or any combination thereof. In general, automated driving module(s) 160 may function to implement different levels of automation, including advanced driving assistance (ADAS) functions, semi-autonomous functions, and fully autonomous functions. “Driving maneuver” means one or more actions that affect the movement of a vehicle. Examples of driving maneuvers include accelerating, decelerating, braking, turning, moving in a lateral direction of vehicle 100, changing travel lanes, merging into a travel lane, and reversing, just to name a few possibilities. Automated driving module(s) 160 may be configured to implement driving maneuvers. Automated driving module(s) 160 may cause, directly or indirectly, such autonomous driving maneuvers to be implemented. As used herein, “cause” or “causing” means to make, command, instruct, enable, or in any combination thereof an event or action to occur or at least be in a state where such event or action may occur, either in a direct or indirect manner. Automated driving module(s) 160 may be configured to execute various vehicle functions, whether individually or in combination, to transmit data to, receive data from, interact with, or to control vehicle 100 or one or more systems thereof (e.g., one or more of vehicle systems 140).

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-9, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components, or processes described above may be realized in hardware or a combination of hardware and software and may be realized in a centralized fashion in one processing system or in a distributed fashion where different elements are spread across several interconnected processing systems. Any kind of processing system or another apparatus adapted for carrying out the methods described herein is suited. A typical combination of hardware and software may be a processing system with computer-usable program code that, when being loaded and executed, controls the processing system such that it carries out the methods described herein. The systems, components, or processes also may be embedded in a computer-readable storage, such as a computer program product or other data programs storage device, readable by a machine, tangibly embodying a program of instructions executable by the machine to perform methods and processes described herein. These elements also may be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that may contain or store a program for use by or in connection with an instruction execution system, apparatus, or device.

Generally, modules as used herein include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™ Smalltalk, C++, or the like and conventional procedural programming languages, such as the “C” programming language or similar programming languages. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC, or ABC).

Aspects herein may be embodied in other forms without departing from the spirit or essential attributes thereof. Accordingly, reference should be made to the following claims, rather than to the foregoing specification, as indicating the scope hereof.

What is claimed is:

1. A system, comprising:
a processor; and
a memory communicably coupled to the processor and storing machine-readable instructions that, when executed by the processor, cause the processor to:
receive trace data;
process the trace data to provide a group of passes within a lane segment;
determine error measurements for the group of passes within the lane segment;
receive a criterion; and
determine an estimated number of passes to satisfy the criterion based on the error measurements.

2. The system of claim 1, wherein the machine-readable instruction to determine the error measurements for the group of passes within the lane segment further includes for each pass added to the lane segment beyond a first pass, to correct an estimated trajectory based on all passes added within the lane segment and then calculate one of the error measurements.

3. The system of claim 2, wherein the machine-readable instruction to calculate one of the error measurements is based on a comparison using a groundtruth trajectory.

4. The system of claim 3, wherein the groundtruth trajectory is based on a corrected estimated trajectory after a final pass has been added to the lane segment.

5. The system of claim 3, wherein the machine-readable instruction to calculate one of the error measurements is further based on absolute pose error or relative pose error.

6. The system of claim 3, wherein the criterion is that an error measurement be below a threshold.

7. The system of claim 3, wherein the machine-readable instructions to determine the estimated number of passes to satisfy the criterion based on the error measurements further includes estimating a trendline with respect to the error measurements.

8. The system of claim 4, wherein the criterion is that a difference between two error measurements from one to pass to another is below a threshold.

9. A non-transitory computer-readable medium including instructions that when executed by one or more processors cause the one or more processors to:
receive trace data;
process the trace data to provide a group of passes within a lane segment;
determine error measurements for the group of passes within the lane segment;
receive a criterion; and
determine an estimated number of passes to satisfy the criterion based on the error measurements.

10. The non-transitory computer-readable medium of claim 9, wherein the instruction to determine the error measurements for the group of passes within the lane segment further includes for each pass added to the lane segment beyond a first pass, to correct an estimated trajectory based on all passes added within the lane segment and then calculate one of the error measurements.

11. The non-transitory computer-readable medium of claim 10, wherein the instruction to calculate one of the error measurements is based on a comparison using a groundtruth trajectory.

12. The non-transitory computer-readable medium of claim 11, wherein the groundtruth trajectory is based on a corrected estimated trajectory after a final pass has been added to the lane segment.

13. The non-transitory computer-readable medium of claim 11, wherein the instruction to calculate one of the error measurements is further based on absolute pose error or relative pose error.

14. The non-transitory computer-readable medium of claim 11, wherein the criterion is that an error measurement be below a threshold.

15. The non-transitory computer-readable medium of claim 11, wherein the instruction to determine the estimated number of passes to satisfy the criterion based on the error measurements further includes estimating a trendline with respect to the error measurements.

16. A method, comprising:
receiving trace data;
processing the trace data to provide a group of passes within a lane segment;
determining error measurements for the group of passes within the lane segment;
receiving a criterion; and
determining an estimated number of passes to satisfy the criterion based on the error measurements.

17. The method of claim 16, wherein determining the error measurements for the group of passes within the lane segment further includes for each pass added to the lane segment beyond a first pass, correcting an estimated trajectory based on all passes added within the lane segment and then calculating one of the error measurements.

18. The method of claim 17, wherein calculating one of the error measurements is based on a comparison using a groundtruth trajectory.

19. The method of claim 18, wherein the groundtruth trajectory is based on a corrected estimated trajectory after a final pass has been added to the lane segment.

20. The method of claim 18, wherein calculating one of the error measurements is further based on absolute pose error or relative pose error.
